(19) United States
(12) Patent Application Publication
(10) Pub. No.: US 2016/0273666 A1
(43) Pub. Date: Sep. 22, 2016

(54) MECHANICAL VALVE FOR A WATERLESS URINAL

(71) Applicants: Edward Michael Goldsmith, Encino, CA (US); Falcon Waterfree Technologies, LLC, Los Angeles, CA (US)

(72) Inventor: Edward Michael Goldsmith, Encino, CA (US)

(21) Appl. No.: 14/418,941

(22) PCT Filed: Jan. 20, 2015
(86) PCT No.: PCT/US2015/012100

§ 371 Date: Jan. 31, 2015

Related U.S. Application Data
(60) Provisional application No. 61/929,131, filed on Jan. 20, 2014.
(60) Provisional application No. 62/004,152, filed on May 28, 2014.

(51) Int. Cl. F16K 15/14; E03C 1/298; E03C 1/264; E03D 13/00

(52) U.S. Cl. CPC F16K 15/147; E03D 13/007; E03C 1/298; E03C 1/264

(57) ABSTRACT

Described is a duckbill valve assembly for connecting with a waterless urinal. The assembly includes a sleeve for containing a duckbill valve therein. The duckbill valve includes a trough with two substantially parallel sheets forming a sealing area. At least one of the substantially parallel sheets includes a side pleat. When the parallel sheets separate as the valve opens, the side pleat expands, increasing the opening cross-sectional area over that afforded by the parallel sheets alone.

### CROSS-REFERENCE TO RELATED APPLICATIONS

This application claims the benefit of U.S. Provisional Application No. 61/929,131, filed Jan. 20, 2014, titled “Mechanical Valve for Waterless Urinal” and U.S. Provisional Application No. 62/004,152, filed on May 28, 2014, entitled, “Mechanical Valve for a Waterless Urinal.”

### BACKGROUND OF THE INVENTION

### (1) Field of Invention

The present invention relates to waterless urinals and, more particularly, to a mechanical duckbill valve for a waterless urinal cartridges that provides for improved thud flux through the valve when it is open as well as to a mechanical duckbill valve and mechanisms for ensuring proper valve seal.

(2) Description of Related Art

Water is a scarce and diminishing resource in many areas of the world. It is widely recognized that more has to be done to conserve its usage as populations grow and climates change. Water conserving products are becoming more and more important not only for quality of human life but also for sanitary and subsistence reasons.

There have been many water conserving measures taken all over the world in an effort to deal with limited and diminishing resources. Many municipalities have developed rationing plans. Others have invested in waste water recycling treatment and re-use. There have also been many water-conserving products introduced into the marketplace. These products are being more widely used by industry and homeowners as regulations become stricter and the costs of water usage rise.

Non-flushing urinal designs use far less water than traditional urinals, saving up to 40,000 gallons of water per year from a single urinal. Non-flushing urinals are made of three major components: a porcelain urinal, a housing, and a cartridge. The porcelain urinal component is very similar to a traditional urinal. The housing replaces a traditional P-trap which normally would connect a urinal to the building's plumbing. Thus, the housing sits in-line between the building's plumbing and the bottom of the urinal where the drain pipe would normally connect. The cartridge operates as the P-trap and fits in the housing in a sealed air-tight manner, and can be removed for servicing and replacement.

A mechanical trap acts as a seal against gas and odor emanating from the building's waste pipes. Human urine is an aqueous solution of greater than 95% water, with the remaining constituents, in order of decreasing concentration being urea 9.3 g/L, chloride 1.87 g/L, sodium 1.17 g/L, potassium 0.750 creatinine 0.670 g/L, and other dissolved ions, inorganic and organic compounds according to the NASA Contractor Report No. NASA CR-1802, D. F. Putnam, July 1971. The mechanical valve system works in a similar fashion to a duckbill valve—which is a well-known type of elastomeric one way valve—allowing flow of fluid in one direction, while sealing against back flow of both fluid and low pressure gas.

Waterless urinals have a unique requirement that most duckbill valves are not designed to handle; very low pressure back flow of gas. Back pressure is a key part of the mechanism that closes a traditional duckbill valve. Without it, the duckbill may not close. In order to deal with this very low pressure environment, waterless urinal valves, unlike traditional duckbill valves, are equipped with an elongated sealing area. As a user urinates into the urinal, fresh urine enters the valve and forcing the valve to open draining the urine into the building's plumbing, the valve then reseals. It is critical for the valve to both open under this low pressure of flowing urine, and then reseal against gas and odor residing in the building's waste pipes just below.

As the market changes and more and more building owners, maintenance personnel, and other decision makers look to save water, mechanical valves may be installed in existing urinals that still have a flushing mechanism. The flushing mechanism—like a “flushometer” manufactured by Sloan Valve Company (located at 10500 Seymour Avenue, Franklin Park, Ill. 60131, USA)—can then be set to flush on a timed interval basis (rather than for every user)—thus preventing water from being flushed with each time the urinal is used. The mechanical valve provides for sealing of sewer gas, while an occasional flush from the flushometer or cistern helps keep the bowl clean and rinse the pipes. However, this poses a new challenge; the valve must also accommodate the more significant flow of fluid that occurs when a flush occurs—as compared to just urination. Finally, as most of the valves today are made of an elastomer (e.g., molded silicone), over time the valves tend to stiffen and work less efficiently due to repeated exposure to harsh chemicals and liquids from urine to chlorine-based cleaners.

Waterless urinal valve performance is critical for safety and pleasant experience by the end user. Small subtleties in design can have a large effect on functionality. The present invention brings new geometries as well as combines new recipes in creating a better more reliable waterless urinal valve. For the reasons above, a need exists for an improved mechanical valve for a waterless urinal. Such a valve would open easily to allow slow flowing urine through, close with little or no hack pressure, and also handle a higher volume of flow when it is flushed with traditional means or a bucket of water is dumped into the urinal. It is the focus of the present invention to solve these problems and provide the end user an improved mechanical valve for a waterless urinal.

### SUMMARY OF THE INVENTION

The present invention relates to waterless urinals and, more particularly, to a mechanical duckbill valve for a waterless urinal cartridges that provides for improved fluid flux through the valve when it is open as well as to a mechanical duckbill valve and mechanisms for ensuring proper valve seal.

In a first aspect, the present invention teaches duckbill valve comprising a throat area connected with two substantially parallel sheets forming a sealing area, where at least one of the substantially parallel sheets further comprises a side pleat. When the parallel sheets separate as the valve opens, the side pleat expands, increasing the opening cross-sectional area over that afforded by the parallel sheets alone.

In another aspect, a portion of at least one of the parallel sheets extends beyond the side pleats.

In still another aspect, the side pleat has a profile selected from a group consisting of a convex profile, a concave profile, and a tapered profile.

In yet another aspect, the sheets have ends and where the end of at least one of the sheets is formed convexly with respect to the end of the other sheet.

In a further aspect, the present invention teaches an assembly for containing a duckbill valve, where the assembly comprises a fin for fitting between parallel sheets of a valve and a sleeve portion for connecting with a portion of the fin for retaining the valve therebetween.

In a still further aspect, the fin has a profile selected from a group consisting of a convex profile, a concave profile, and a tapered profile.

In a yet further aspect, the fin further comprises a side extension for attaching with the sleeve portion.

In another aspect, the side extension of the fin has a profile selected from a group consisting of a convex profile, a concave profile, and a tapered profile.

In still another aspect, the assembly further comprises a cap for connecting with the sleeve to retain a portion of a duckbill valve therebetween.

In a further aspect, the assembly further comprises a filter for preventing particulates from entering the valve. The filter may be formed as part of the cap.

In a yet further aspect, the present invention teaches a valve/fin assembly comprising a duckbill valve comprising a throat area connected with two substantially parallel sheets forming a sealing area and a fin for conformingly fitting between the parallel sheets of the valve to provide an improved seal between the sheets and the fin.

In a still further aspect, the sheets have ends and where the end of at least one of the sheets is formed convexly with respect to the end of the other sheet, whereby a middle portion of the convexly formed sheet connects tightly with the fin.

In another aspect, the fin has an end with sides and where the end of the fin is proximate the ends of the sheets, and where at least one of the sides of the end of the fin is formed to conform with the end of the sheet that is formed convexly.

In still another aspect, the valve further comprises a side pleat, whereby when the parallel sheets separate as the valve opens, the side pleat expands, increasing the opening cross-sectional area over that afforded by the parallel sheets alone.

In yet another aspect, the fin further comprises a side extension for fitting with the side pleat of the valve.

In a further aspect, the side pleat of the valve and the side extension of the fin have matching profiles selected from a group consisting of convex profiles, concave profiles, and tapered profiles.

Finally, as can be appreciated by one in the art, the present invention also comprises a method for forming and using the invention described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a front-view of a prior art waterless urinal duckbill valve;

FIG. 2 is a front, cross-sectional view of a prior art duckbill valve for a waterless urinal;

FIG. 3 is a side, cross-sectional view of a prior art duckbill valve for a waterless urinal;

FIG. 4 is a top-view of a prior art duckbill valve for a waterless urinal;

FIG. 5 is a front-view of a duckbill valve with a pleat in a portion of the sealing area, according to the principles of the present invention;

FIG. 6 is a front, cross-sectional view a duckbill valve with a pleat in a portion of the sealing area, according to the principles of the present invention;

FIG. 7 is a side, cross-sectional view of a duckbill valve with a pleat in a portion of the sealing area and a gap at the intersection of the sealing area and the trough, according to the principles of the present invention;

FIG. 8 is a side, cross-sectional view of a duckbill valve with a pleat in a portion of the sealing area and a gap at the intersection of the sealing area and the trough, depicting a wedge shaped fin positioned between the two sealing portions, filling the gap, according to the principles of the present invention;

FIG. 9 is a top-view of a duckbill valve with a pleat in a portion of the sealing area and a gap at the intersection of the sealing area and the trough, according to the principles of the present invention;

FIG. 10 is a front-view of a duckbill valve with a pleat in the sealing area that extends into the trough, according to the principles of the present invention;

FIG. 11 is a front, cross-sectional view of a duckbill valve with a pleat in the sealing area that extends into the trough, according to the principles of the present invention;

FIG. 12 is a side, cross-sectional view of a duckbill valve with a pleat in the sealing area, that extends into the trough, and a gap at the intersection of the trough and the sealing area, according to the principles of the present invention;

FIG. 13 is a top-view of a duckbill valve with a pleat in the sealing area, that extends into the trough, and a gap at the intersection of the trough and the sealing area, according to the principles of the present invention;

FIG. 14 is a side, cross-sectional view of a duckbill valve with a pleat in the sealing area, that extends into the trough, and a gap at the intersection of the trough and the sealing area, along with a wedge shaped fin inserted into the gap, according to the principles of the present invention;

FIG. 15 is a side, cross-sectional view of a duckbill valve with a convex pleat in the sealing area, that extends into the trough and a gap at the intersection of the trough and the sealing area, along with a wedge shaped fin inserted into the gap, according to the principles of the present invention;

FIG. 16 is an isometric view of a fin for a valve for a waterless urinal, according to the principles of the present invention;

FIG. 17 is a front-view of a fin for a valve for a waterless urinal, according to the principles of the present invention;

FIG. 18 is a front-view of a duckbill valve with a pleat in a portion of the sealing area;

FIG. 19 is a front-view of a duckbill valve with a pleat in a portion of the sealing area, and a fin inserted into the valve gap, according to the principles of the present invention;

FIG. 20 is a side, cross-sectional view of a sleeve for holding the duckbill valve for a waterless urinal, according to the principles of the present invention;

FIG. 21 is a side-view of a sleeve and cap in exploded view form, for holding the duckbill valve for a waterless urinal, according to the principles of the present invention;

FIG. 22 is the same sleeve and cap shown in FIG. 21, now turned 90 degrees, according to the principles of the present invention;

FIG. 23 depicts a valve, seen in dotted line, with a pleat in a portion of the sealing area, inserted into a sleeve, with a fin placed in the gap of the sealing area of the valve, according to the principles of the present invention;

FIG. 24 is a cross-sectional view of a housing for a waterless urinal cartridge, according to the principles of the present invention;

FIG. 25 is a housing seen in cross-section with a cartridge non cross-sectioned inserted in the housing for a waterless urinal, according to the principles of the present invention;

FIG. 26 is a top-view of the housing according to the to present invention, depicting cartridge positioned within the housing;

FIG. 27 is a side-view of a housing for a waterless urinal cartridge, according to the principles of the present invention;

FIG. 28 is a side, cutaway-view of a waterless urinal, showing a non cutaway-view of the housing inserted into the urinal, according to the principles of the present invention;

FIG. 29A is a side view of a valve having sheets with tapered pleats, according to the principles of the present invention;

FIG. 29B is a top view of a valve and the fin, according to the principles of the present invention; and

FIG. 29C is a bottom view taken through cross-section A-A of FIG. 29A, according to the principles of the present invention.

### DETAILED DESCRIPTION

The present invention relates to waterless urinals and, more particularly, to a mechanical duckbill valve for a waterless urinal cartridges that provides for improved fluid flux through the valve when it is open as well as to a mechanical duckbill valve and mechanisms for ensuring proper valve seal. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C., Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

Before describing the invention in detail, an introduction is provided to provide the reader with a general understanding of the present invention. Finally, specific details of the present invention are provided to give an understanding of the specific aspects.

(1) Introduction

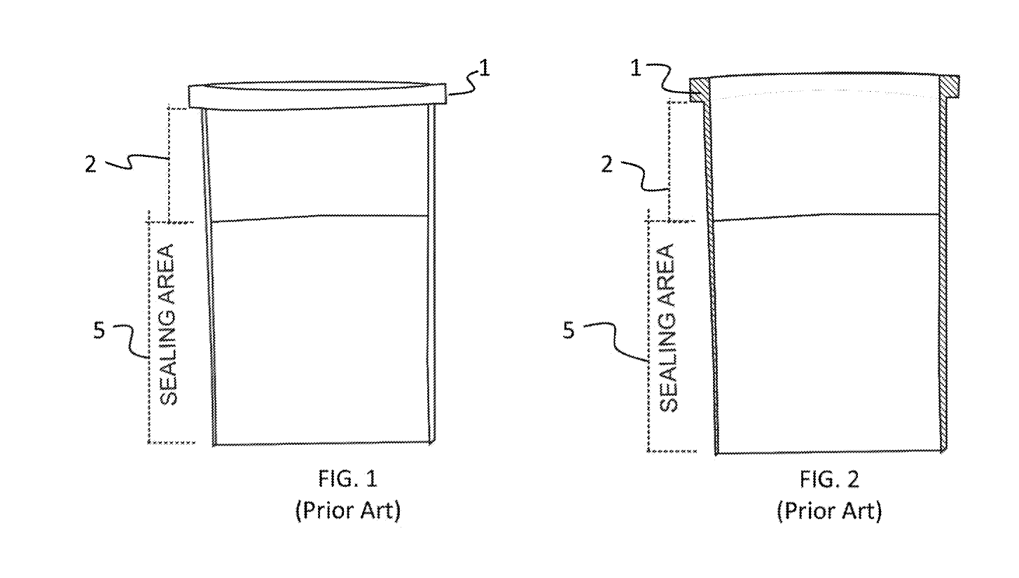

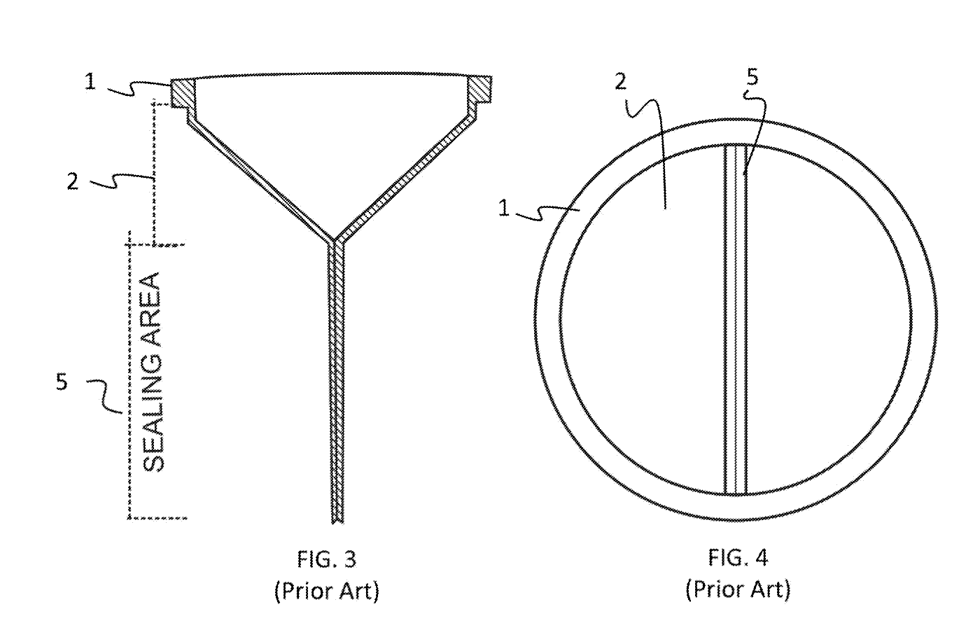

Non-flushing urinals use the least amount of water of any urinal systems, relying on one of two types of a trap to seal out gas and odor, the first is a mechanical trap and the second is a liquid trap with a lighter than wastewater liquid barrier. An example of a prior art mechanical trap is shown in FIGS. 1 through 4. Specifically, FIG. 1 provides a front-view illustration of a prior art waterless urinal duckbill valve, while FIGS. 2 through 4 provide a front cross-sectional view, a side cross-sectional view, and a top-view, respectively, of the prior art duckbill valve. As shown in FIGS. 1 through 4, the duckbill valve of the prior art includes a rib 1, a trough 2, and sealing area 5. While generally operable, a problem with such duckbill mechanical valves is that the sealing area 5 does not include any mechanical feature to form a tight seal. As a result, a traditional duckbill valve may have a tendency to leak, particularly over time. If the sealing area 5 is fortified to prevent leakage, the valve may be difficult to open, which decreases the flushing operations of such a valve.

Thus, the present invention is intended to overcome many of the shortcomings of the mechanical valve or the “valve” trap non-flushing urinal systems whose challenge is to balance sealing, ease of opening, and over-all flow rate. It accomplishes this by adding pleats and a central concentrating area to a waterless urinal valve, and shaping these components in an optimized fashion. The ultimate goal is to allow low “crack pressure” or ease of initial opening, while also having superior sealing. Finally it is also a goal of the present invention to increase flow rate over existing valve technology. Thus, users can, for example, dump a bucket of water or utilize the valve in combination with a traditional flush urinal—set to flush on a timed basis—without fear of slow flow, or sticking valve; both of which would cause flooding when flushed. Specific details of the waterless urinal valve according to the principles of the present invention are provided below.

(2) Specific Details

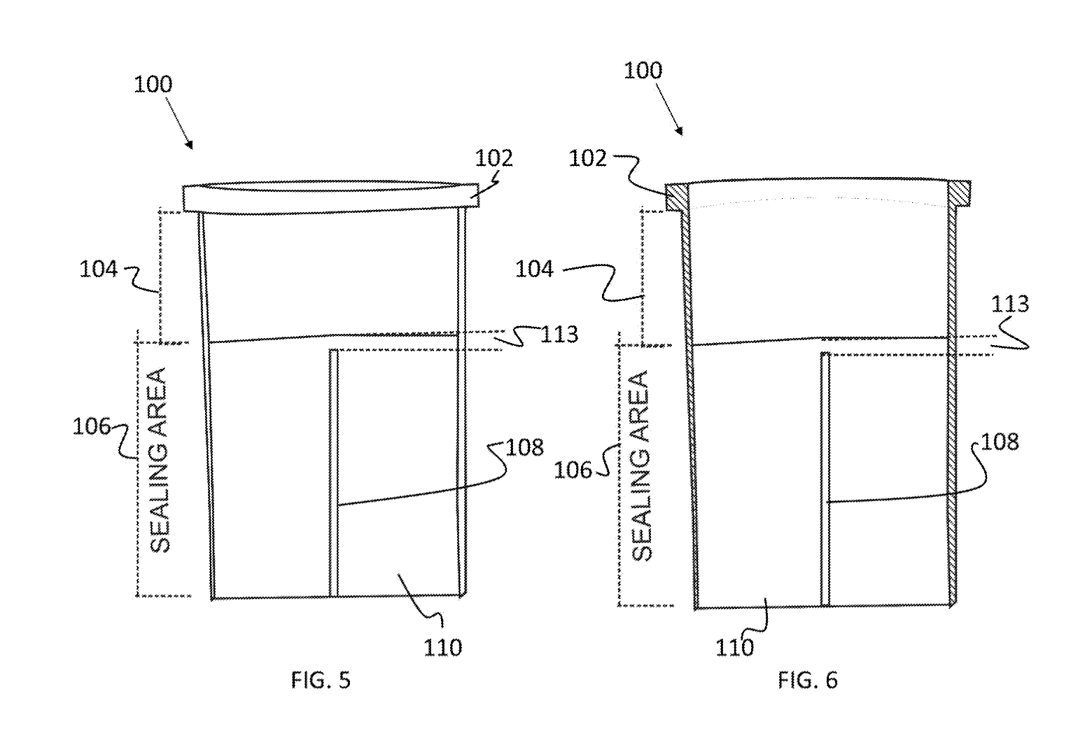

As noted above, the present invention is directed to an improved duckbill valve for a waterless urinal. FIGS. 5 and 6 provide front-view, and cross-sectional view illustrations, respectively, of one aspect of the duckbill valve 100. As was the case with the prior art, the valve 100 includes a rib 102, a trough 104, and a sealing area 106. However, to be contrasted with the prior art, the valve 100 according to the principles of the present invention includes side pleats 108 formed in a portion of the sealing area 106. As understood by those skilled in the art, the side pleats 108 are, in aspect, folds formed by doubling the material (i.e., parallel sheets 110) back upon itself. In another aspect, the side pleats 108 are channels or recesses formed in the parallel sheets 110. However, desirably, the side pleats 108 are folds as described above.

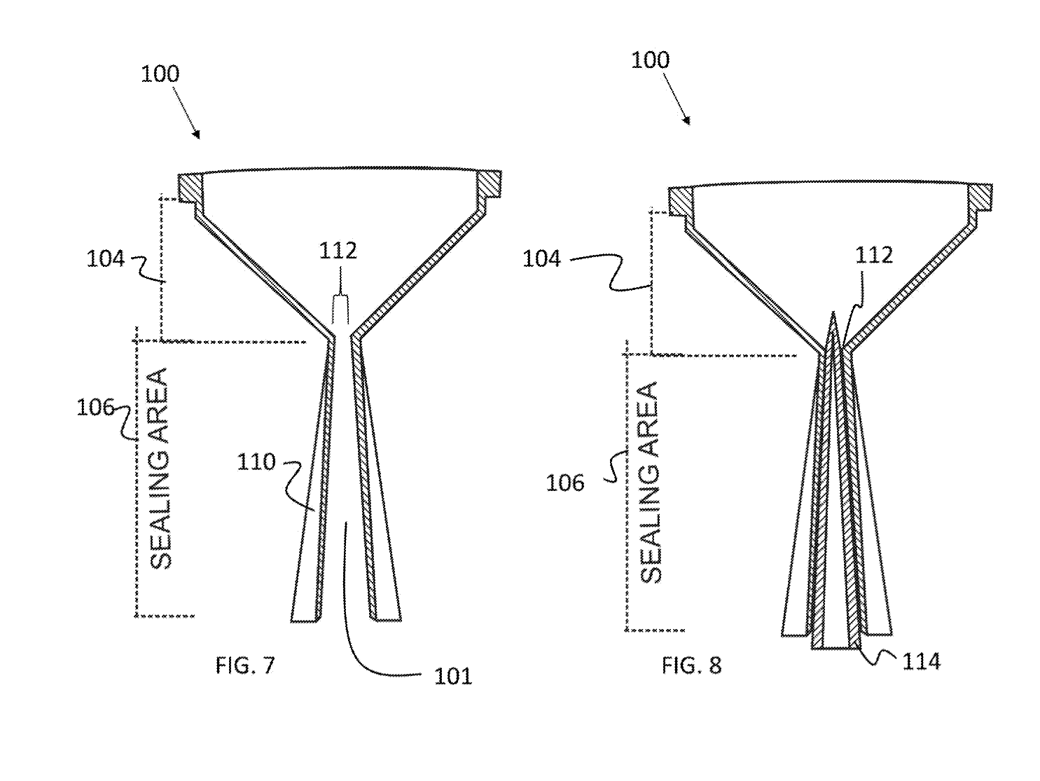

As shown in the side-view illustration of FIG. 7, the valve 100 includes a throat area 101 connected with two substantially parallel sheets 110 forming the sealing area 108. In this aspect, at least one (or both) of the substantially parallel sheets 110 includes a side pleat 108. When the parallel sheets 110 separate as the valve opens, the side pleat 108 expands, increasing the opening cross-sectional area over that afforded by the parallel sheets 110 alone. Although not limited thereto, the aspect as depicted in FIGS. 5 and 6 illustrates the side pleat 108 formed in the sheet 110 (and thereby the sealing area 106). As shown in the side-view of FIG. 7, the valve 100 is formed such that a gap 112 exists between the sheets 110 at the intersection of the sealing area 106 and the trough 104. Further, the pleats 108 can be formed such that a space 113 exists between the pleats 108 and the trough 104. Thus, in this aspect, a portion of the parallel sheets 110 extend beyond the side pleats 108.

It should be understood that the side pleats 108 can be formed in any suitable shape. As a non-limiting example, the side pleat 108 has a profile selected from a group consisting, of a convex profile, a concave profile, and a tapered profile. Further, it should be understood that the sheets 110 can be formed in any desired shape. As a non-limiting example, the sheets 110 have ends and the end of at least one of the sheets 110 is formed convexly with respect to the end of the other sheet 110. In another aspect, the sheets 110 are formed to have a convex profile, a concave profile, and a tapered profile.

In use, the side pleats 108 allow the valve 100 to open to a larger overall aperture without the walls of the valve—normally made of a compliant material like silicone or other elastomers—having to stretch. This is important as the act of stretching the material creates resistance to fluid passing through. Thus, the side pleats 108 allow the opening of the valve 100 with less fluid slowing resistance than traditional valves. Additionally, the trough 104 creates a narrow column of fluid—even when only a small amount of fluid is introduced. This works through a simple principle of fluid head pressure—which is increased by allowing the fluid to centralize in a column. The trough 104 comes to a point at its lowest downstream region, creating a point load or concentrating force. This head pressure is focused in a tapering manner to a point creates the ability for the valve to open with only a small amount of liquid present. This is a key for providing low “crack” or opening pressure for the valve.

FIG. 8 provides a side, cross-sectional view of another aspect of the duckbill valve 100. In this aspect, the valve 100 includes a pleat in a portion of the sealing area 106 and the gap 112 at the intersection of the sealing area 106 and the trough 104, as was the case above. However, in this aspect, a wedge shaped fin 114 is positioned between the two parallel sheets 110, filling the gap 112.

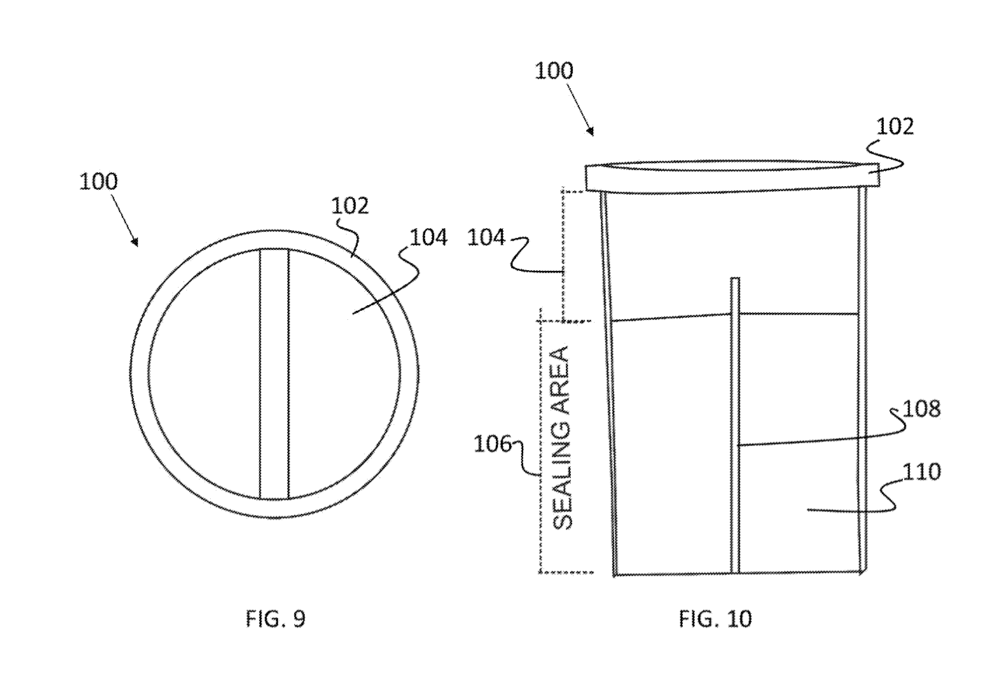

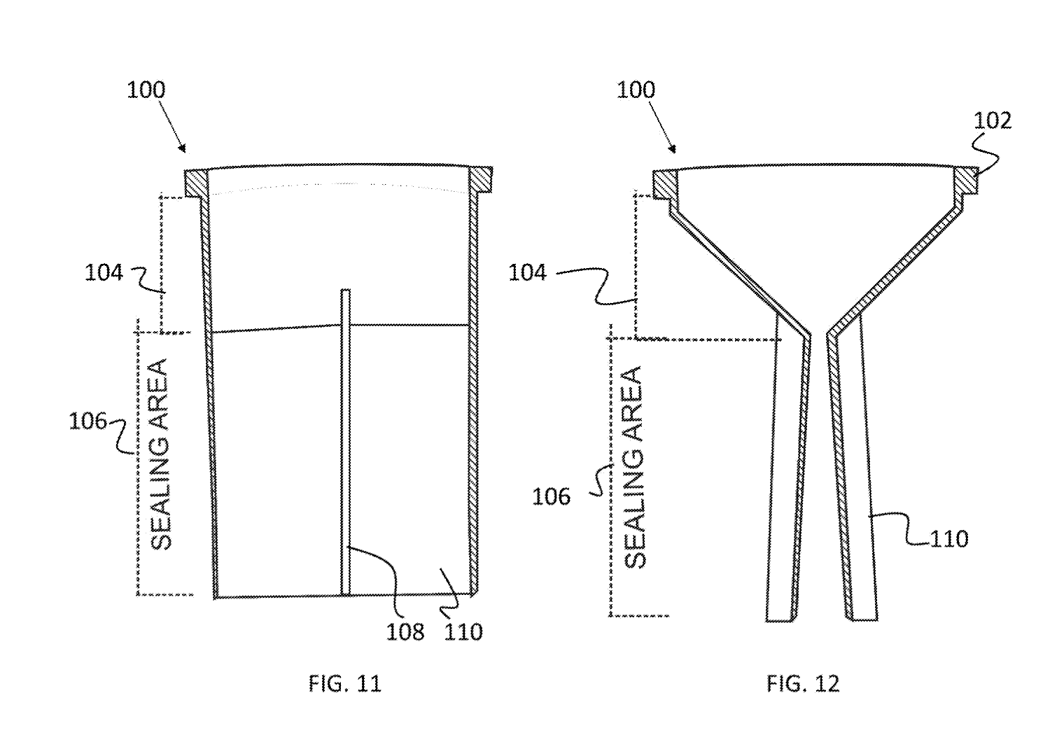

FIGS. 9 through 12 illustrate another aspect of the duckbill valve 100. In this aspect, the valve 100 includes the rib 102, trough 104, and parallel sheets 110 that form the sealing area 106. However, to be contrasted with the aspect as illustrated in FIGS. 5 through 8, the valve 100 as illustrates in FIGS. 9 through 12 includes one or more pleats 108 in the sheets 110 that extend up and into the trough 104.

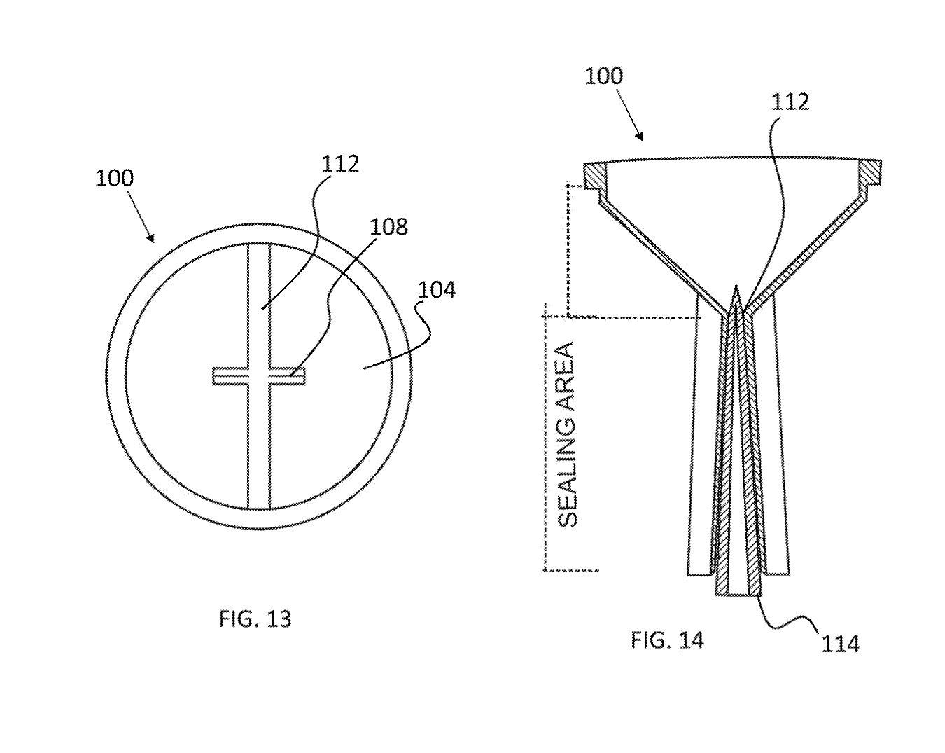

For further understanding, FIG. 13 is a top-view of a duckbill valve 100, illustrating the gap 112 at the intersection of the trough 104 and sealing area. Importantly, FIG. 13 provides an illustration of the pleat 108 as extending into the trough 104. As shown in FIG. 14, such a valve 100 can also receive the wedge shaped fin 114 inserted into the gap 112.

As noted above and as illustrated in FIG. 15, the substantially parallel sheets 110 of the valve 100 can be formed in any desired shape. As a non-limiting example and as illustrated in FIG. 15, the sheets 110 can be formed to have a convex profile.

As noted herein, the fin 114 and sheets 110 can be formed in any desired shape. As a non-limiting example, the sheets 110 have ends and the end of at least one of the sheets 110 is formed convexly with respect to the end of the other sheet 110, whereby a middle portion 116 of the convexly formed sheet connects tightly with the fin 114. In another aspect, the fin 114 has an end with sides and where the end of the fin 114 is proximate the ends of the sheets 110, and where at least one of the sides of the end of the fin 114 is formed to conform with the end of the sheet 114 that is formed convexly.

In another aspect, an advantage to adding the wedge shaped fin 114 is provided by the adjacent focusing troughs 118 that are formed by the tip 120 of the wedge shaped fin 114. In other words, the tip 120 of the wedge shaped fin 114 extends through the gap 112 and into the trough 104. In doing so, adjacent focusing troughs 118 are formed on each side of the tip 120. The adjacent focusing troughs 118 create a tapered volume inside of the valve 100, its point focusing on the point at which the wedge shaped fin 114 seals the gap 112. By focusing the pressure of the fluid on the focusing troughs 118, the valve 100 has both a low crack pressure and high resistance to as and fluid flowing, backwards through the valve 100 (due to the presence of the wedge shaped fin 114).

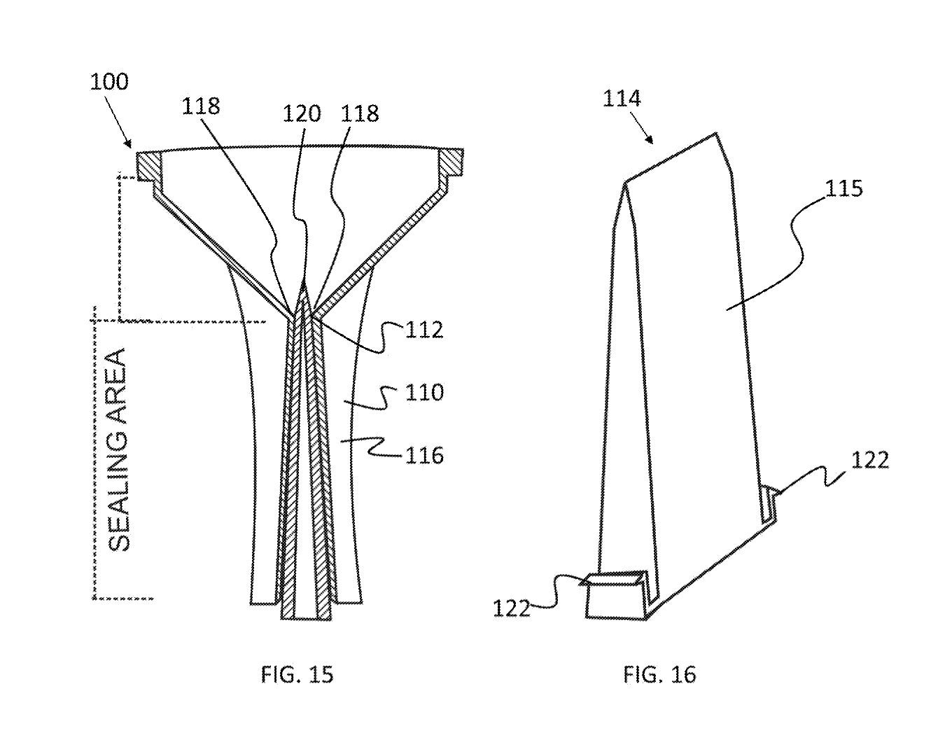

For further understanding, FIG. 16 provides an illustration of the wedge shaped fin 114. The fin 114 can be formed in any desired shape, non-limiting examples of which include having a convex profile, a concave profile, and a tapered profile (as illustrated in FIG. 16).

In another aspect, the fin 114 can be formed such that the sides 115 of the fin 114 include, a side extension for fitting within a side pleat of a duckbill valve with a side pleat. The side extension of the fin has a profile selected from a group consisting of a convex profile, a concave profile, and a tapered profile. These side extensions are configured to conform to the shape of the side pleat of the valve. In yet another aspect, the side pleat of the valve and the side extension of the fin 114 have matching profiles selected from a group consisting of convex profiles, concave profiles, and tapered profiles.

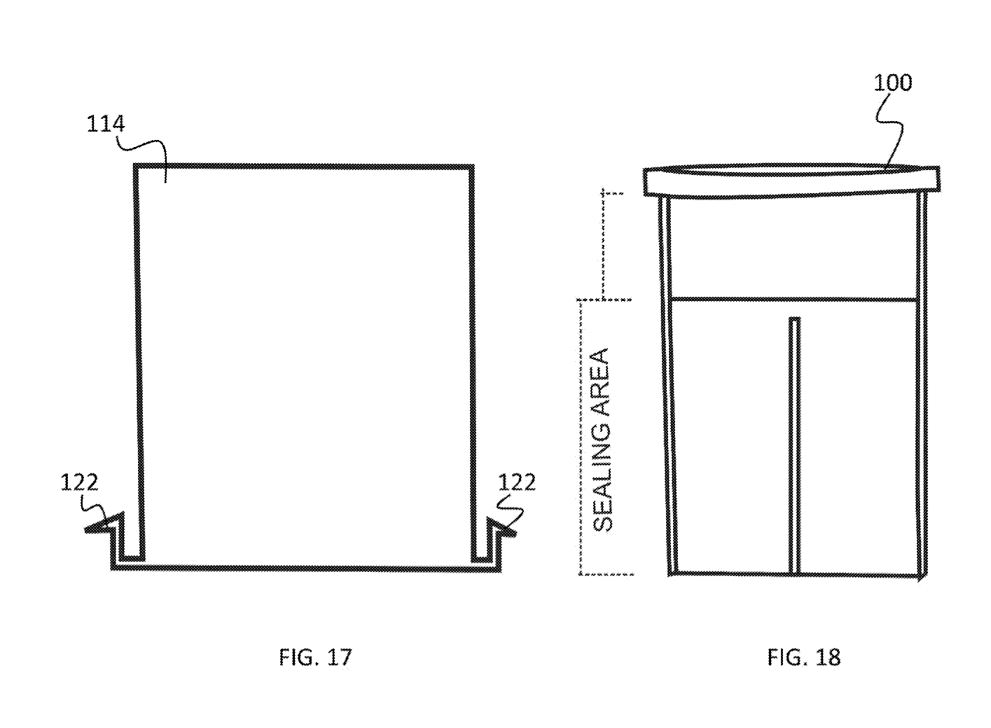

FIG. 17 provides a front-view illustration of a fin 114. As shown, the fin 114 includes a fin attachment (e.g., one or more catch members 122) for attaching with a sleeve (as described below).

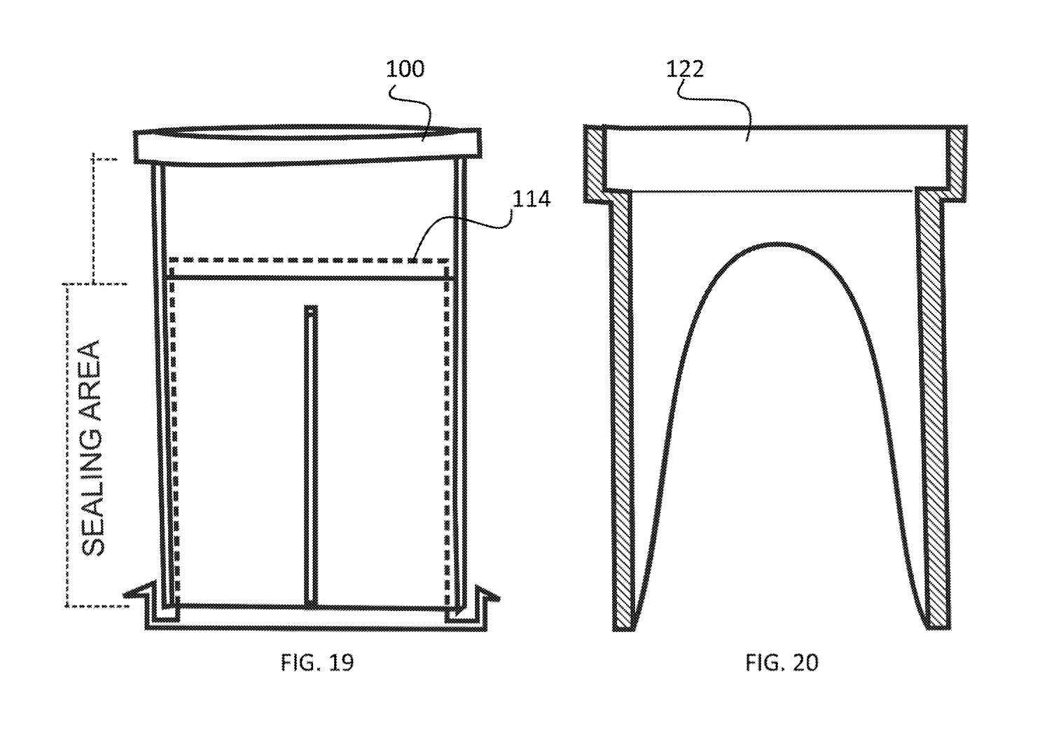

As noted above, the wedge shaped fin 114 is formed to be positioned within a duckbill valve 100, such as that depicted in FIG. 18. FIG. 19 provides a front-view illustration of the fin 114 positioned within such a duckbill valve 100. To hold the valve 100 within a waterless urinal, the invention also includes a sleeve for holding the duckbill valve. The sleeve 124 is any suitable mechanism or device that is operable for securely holding such a duckbill valve in place within a waterless urinal, a non-limiting example of which is illustrated in FIG. 20. Specifically, FIG. 20 provides a side, cross-sectional view of the sleeve 124 for holding the duckbill valve for a waterless urinal.

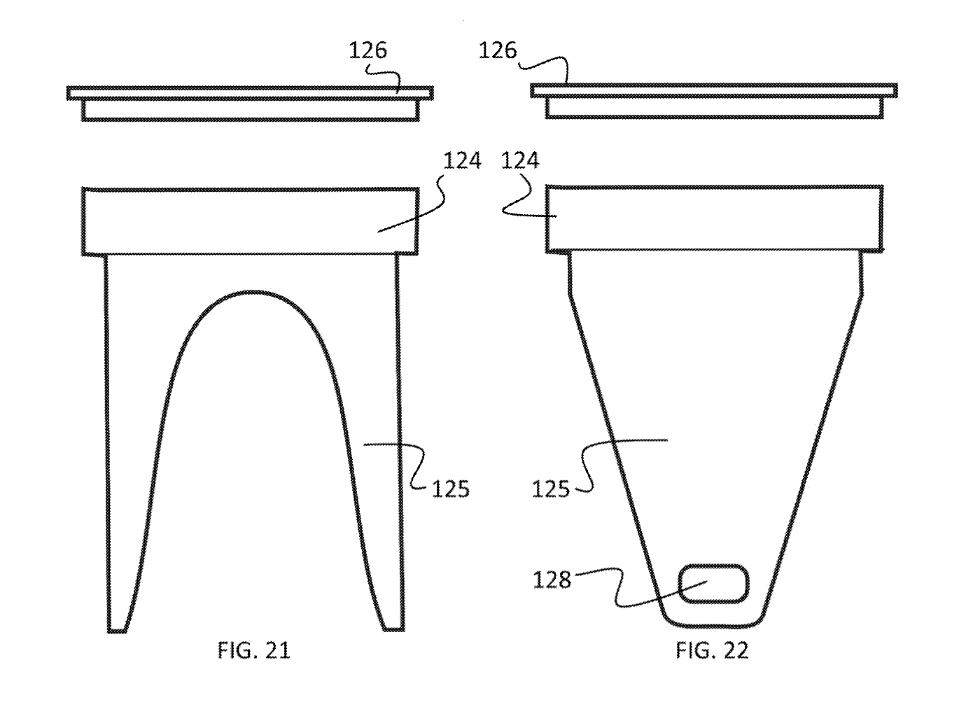

FIG. 21, for example, provides a side-view of the sleeve 124 and cap 126 in an exploded view form. The cap 126 connects with the sleeve 124 to retain a portion of a duckbill valve therebetween.

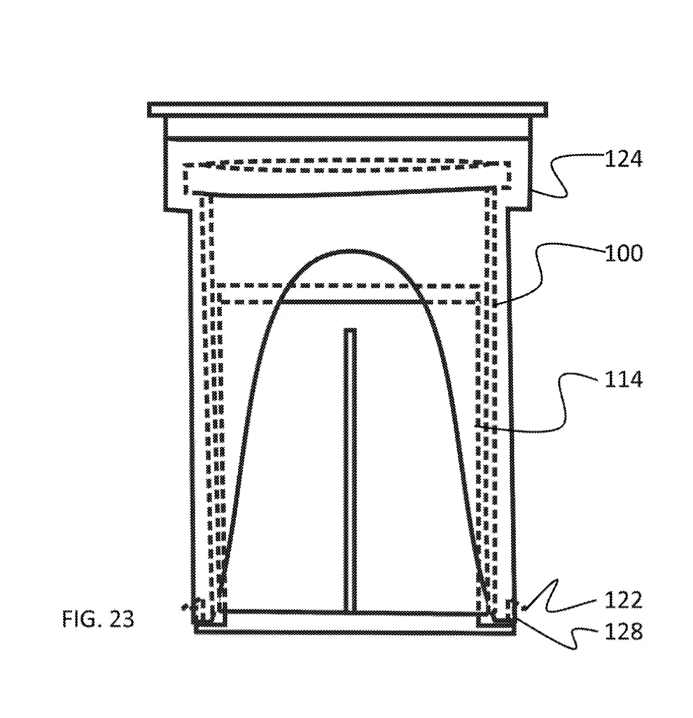

FIG. 22 is the same sleeve 124 and cap 126 seen in FIG. 21, now turned 90 degrees. As shown, the sleeve 124 includes sleeve connector 128 for connecting with the fin attachment. As a non-limiting example an in one aspect, the sleeve 124 includes downwardly projecting saddle portions 125, and the sleeve connector is a hole 128 formed through each of the saddle portions 125. The hole 128 is formed to receive and lock into engagement with the catch members from the fin. This aspect is further illustrated in FIG. 23, which depicts a valve 100, seen in dotted line, inserted into a sleeve 124. A fin 114 is fin placed in the gap of the sealing area of the valve 100. Also depicted are the catch members 122 locked into engagement with and protruding through the holes 128 of the sleeve 124.

As described below, the sleeve 124 and valve 100 collectively operate as a waterless urinal cartridge that can be easily positioned within a waterless urinal and replaced. A housing is used to assist attaching the waterless urinal cartridge in place with the waterless urinal. The housing is any suitable mechanism or device that allows a user to easily attach the waterless urinal cartridge with said waterless urinal, a non-limiting example of which is described below.

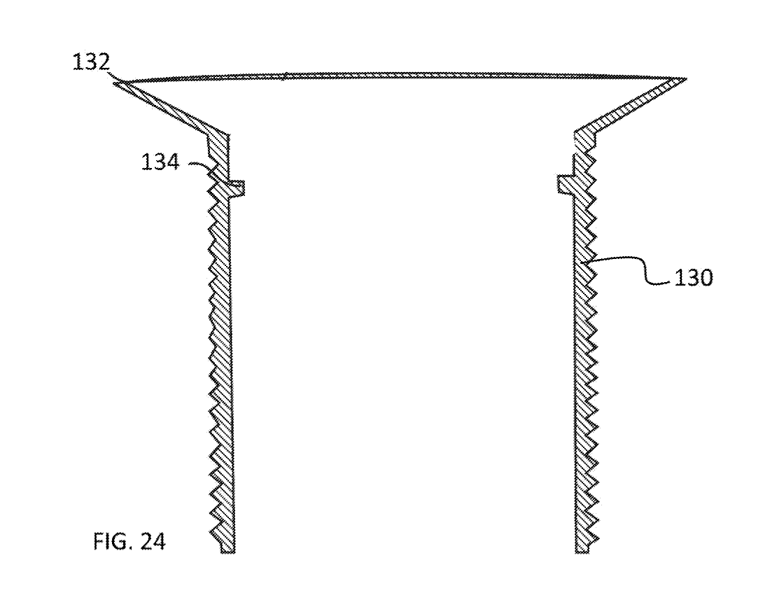

For example, FIG. 24 is a cross-sectional view of the housing 130 for a waterless urinal cartridge. The housing 130 includes a flange 132 to allow the housing 130 to easily rest within a bowl of the waterless urinal. A cartridge holder 134 is also included. The cartridge holder 134 is any suitable mechanism or device that supports the waterless urinal cartridge, a non-limiting example of which includes a ledge that protrudes from an inner wall of the housing 130.

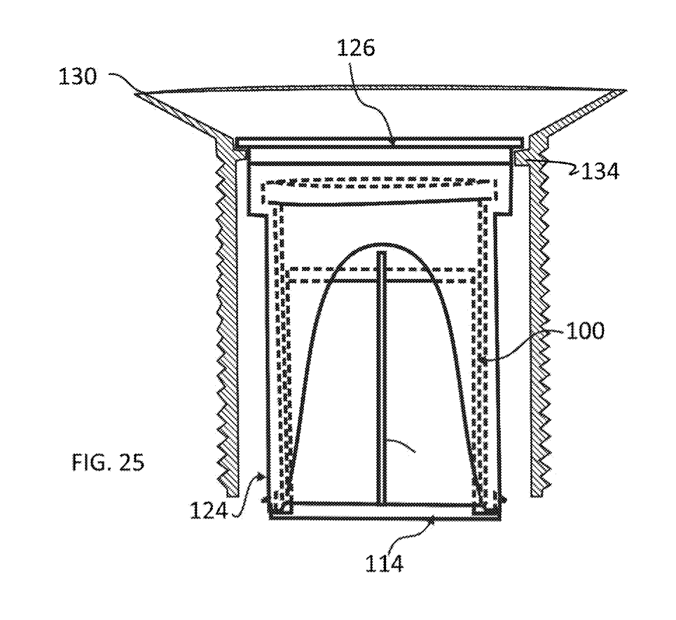

For further understanding, FIG. 25 depicts a housing 130 seen in cross-section with a cartridge (non cross-sectioned) inserted in the housing 130. As shown, the cap 126 rests upon the cartridge holder 134 (i.e., ledge). Also shown is the valve 100 with the pleats 108 and the wedge shaped fin 114 positioned therein.

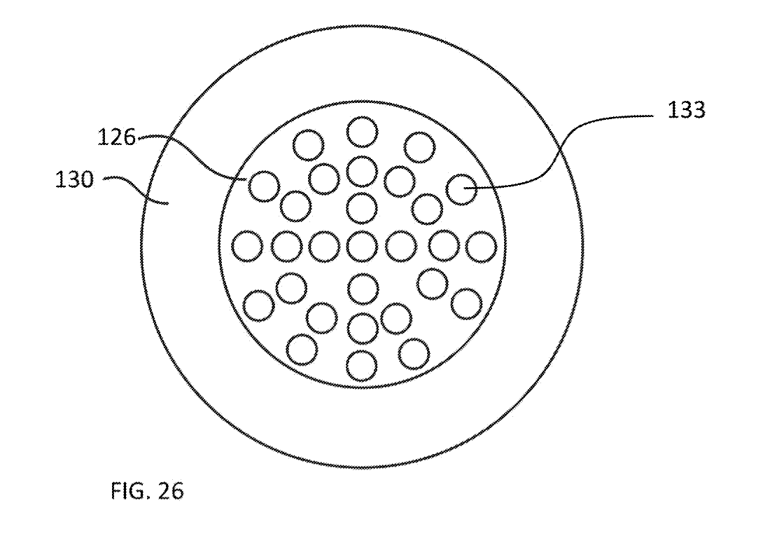

FIG. 26 provides a top-view illustration of the housing 130 according to the principles of the present invention, depicting the cartridge positioned within the housing 130. As shown, the cap 126 can be funned to include a plurality of drain holes 133. The drain holes 133 filter out larger items while allowing fluids (e.g., urine) to pass therethrough and into the valve. In other words, a filter can be included with the assembly for preventing particulates from entering the valve. In one aspect, the filter is formed as part of the cap 126.

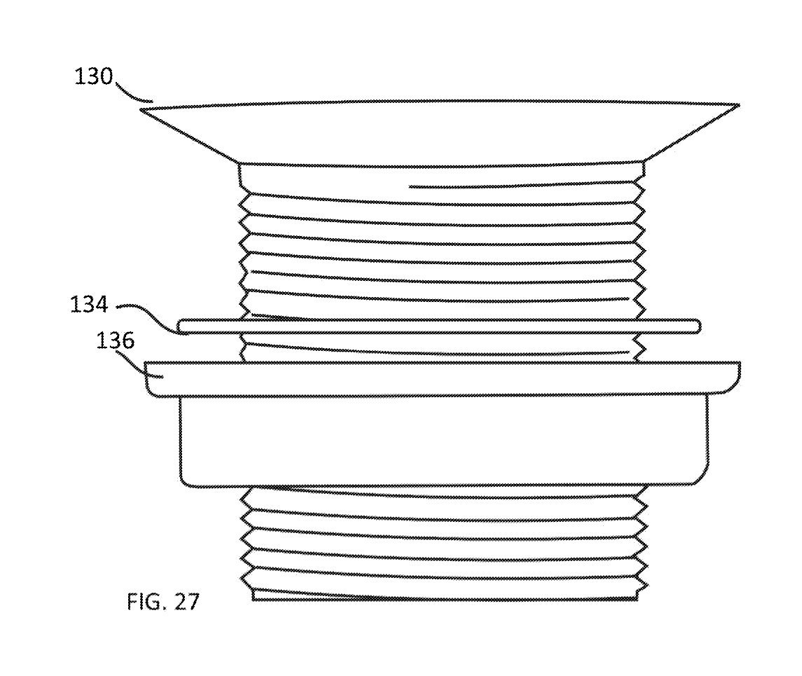

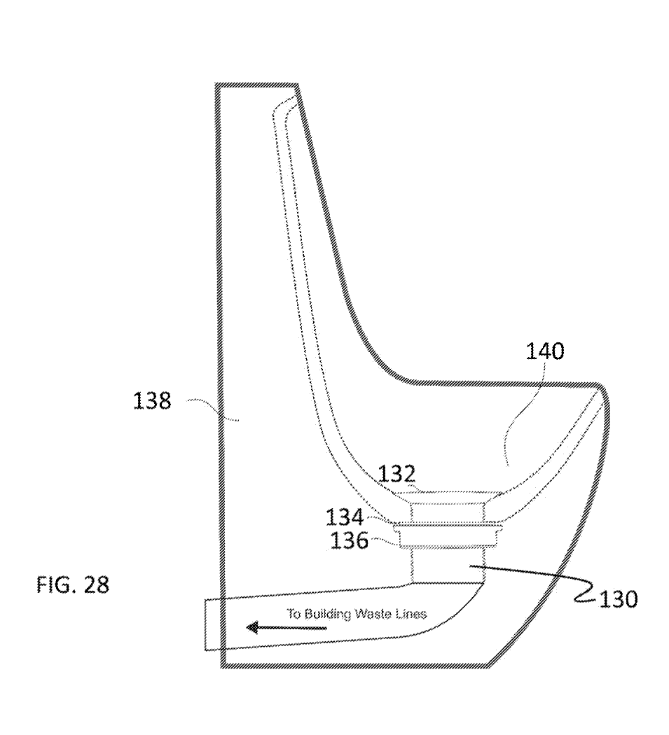

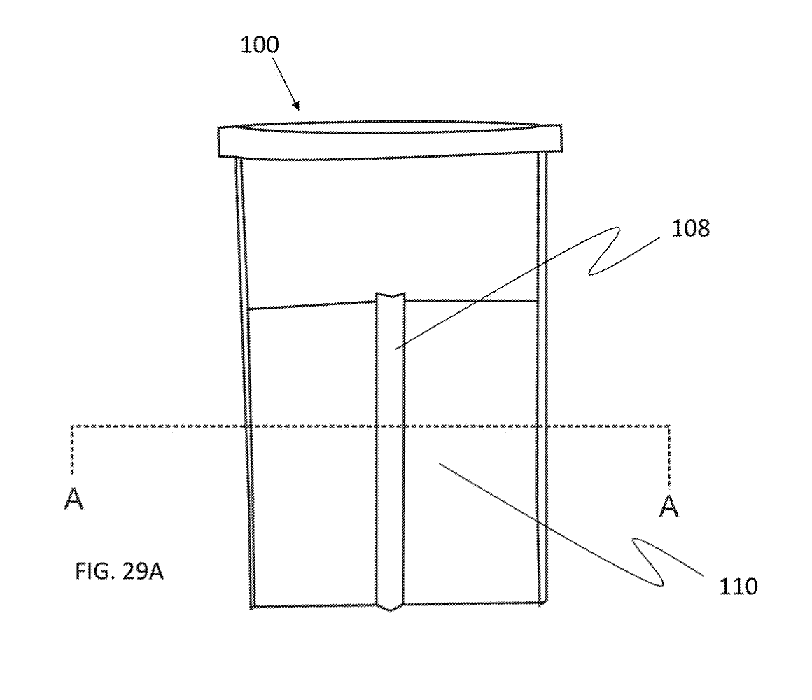

As shown in FIG. 27, to secure the housing 130 in place with respect to the waterless urinal, the housing 130 includes a washer 134 and a locking nut 136. Finally, FIG. 28 provides a side, cutaway-view of a waterless urinal 138, showing a non cutaway-view of the housing 130 inserted into the urinal 138. As shown, the flange 132 rests within the urinal bowl 140, with the washer 134 and locking nut 136 securely affixing the housing 130 in place. Thus, in operation, a user can simply lift the cartridge (i.e., sleeve and valve) out of the housing 130 and replace the cartridge with a fresh or new cartridge.

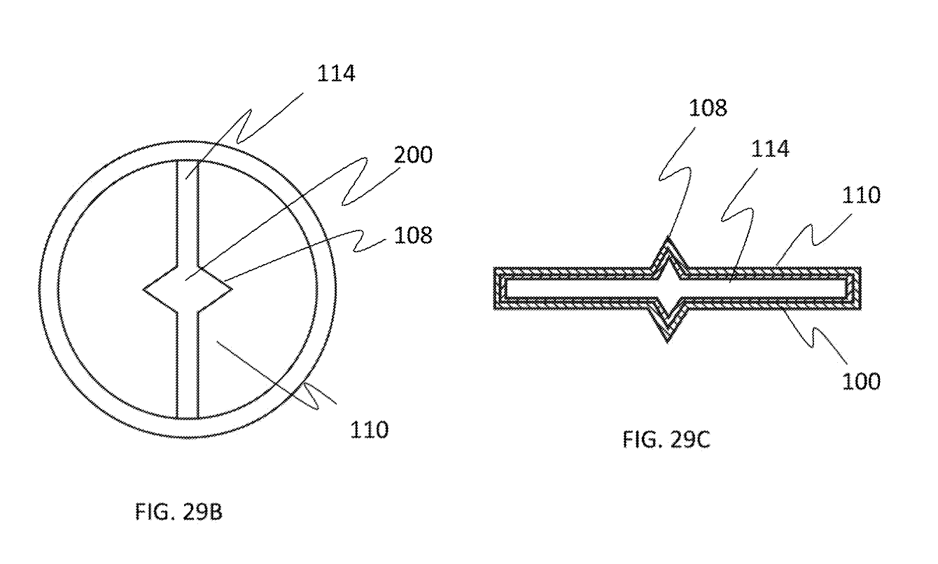

A side view of a valve 100 having sheets 110 with tapered pleats 108 is shown in FIG. 29A. Although not visible in FIG. 29A, a fin 114 having two side extensions 200 which conform with the tapered pleats 108 can be seen in FIG. 29B which shows a top view of the valve 100 and the fin 114. A bottom view taken through cross-section A-A of FIG. 29A is shown in FIG. 29C. Note that the side extensions 200 of the fin 114 as well as the pleats 108 of the valve 100 can be of any desired shape, non-limiting examples of which include tapered, convex, and concave. Further, the profile of the side extensions 200 and of the pleats 108 may vary along their lengths as well, non-limiting examples of which include widening, narrowing, and changing profile (e.g., going from rounded/curved to angular/tapered).

What is claimed is:

1. A duckbill valve comprising a throat area connected with two substantially parallel sheets forming a sealing area, where at least one of the substantially parallel sheets further comprises a side pleat, whereby when the parallel sheets separate as the valve opens, the side pleat expands, increasing the opening cross-sectional area over that afforded by the parallel sheets alone.

2. A duckbill valve as set forth in claim 1, wherein a portion of at least one of the parallel sheets extends beyond the side pleats.

3. A duckbill valve as set forth in claim 1, wherein the side pleat has a profile selected from a group consisting of a convex profile, a concave profile, and a tapered profile.

4. A duckbill valve as set forth in claim 1, where the sheets have ends and where the end of at least one of the sheets is formed convexly with respect to the end of the other sheet.

5. An assembly for containing a duckbill valve, where the assembly comprises a fin for fitting between parallel sheets of a valve and a sleeve portion for connecting with a portion of the fin for retaining the valve therebetween.

6. An assembly as set forth in claim 5, wherein the fin has a profile selected from a group consisting of a convex profile, a concave profile, and a tapered profile.

7. An assembly as set forth in claim 5, where the fin further comprises a side extension for attaching with the sleeve portion.

8. An assembly as set forth in claim 6, wherein the side extension of the fin has a profile selected from a group consisting of a convex profile, a concave profile, and a tapered profile.

9. An assembly as set forth in claim 5, wherein the assembly further comprises a cap for connecting with the sleeve to retain a portion of a duckbill valve therebetween.

10. An assembly as set forth in claim 9, further comprising a filter for preventing particulates from entering the valve.

11. An assembly as set forth in claim 10, where the filter is formed as part of the cap.

12. A valve/fin assembly comprising a duckbill valve comprising a throat area connected with two substantially parallel sheets forming a sealing area and a fin for conformingly fitting between the parallel sheets of the valve to provide an improved seal between the sheets and the fin.

13. An assembly as set forth in claim 12, wherein the sheets have ends and where the end of at least one of the sheets is formed convexly with respect to the end of the other sheet, whereby a middle portion of the convexly formed sheet connects tightly with the fin.

14. An assembly as set forth in claim 12, wherein the fin has an end with sides and where the end of the fin is proximate the ends of the sheets, and where at least one of the sides of the end of the fin is formed to conform with the end of the sheet that is formed convexly.

15. An assembly as set forth in claim 12, wherein the valve further comprises a side pleat, whereby when the parallel sheets separate as the valve opens, the side pleat expands, increasing the opening cross-sectional area over that afforded by the parallel sheets alone.

16. An assembly as set forth in claim 15, where the fin further comprises a side extension for fitting with the side pleat of the valve.

17. An assembly as set forth in claim 16, wherein the side pleat of the valve and the side extension of the fin have matching profiles selected from a group consisting of convex profiles, concave profiles, and tapered profiles.
